(19) United States
(12) Patent Application Publication
(10) Pub. No.: US 2014/0335231 A1
(43) Pub. Date: Nov. 13, 2014

(54) Frozen pizza preparation package and method

(71) Applicants: Michael Weinstein, West Bloomfield, MI (US); Robert E Weinstein, Farmington Hills, MI (US)

(72) Inventors: Michael Weinstein, West Bloomfield, MI (US); Robert E Weinstein, Farmington Hills, MI (US)

(21) Appl. No.: 14/340,006

(22) Filed: Jul. 24, 2014

Related U.S. Application Data
(63) Continuation-in-part of application No. 14/183,602, filed on Feb. 19, 2014.
Application No. 14/183,602 is a continuation-in-part of application No. 14/073,949, filed on Nov. 7, 2013.
(60) Provisional application No. 61/768,603, filed on Feb. 25, 2013.

(51) Int. Cl. A21D 15/02; B65D 81/34; A21D 17/00

(52) U.S. Cl. CPC A21D 15/02; A21D 17/006; A21D 17/004; B65D 81/3446
USPC 426/87; 426/243; 426/393

(57) ABSTRACT

A frozen pizza preparation package and method where the package incorporates a frozen pizza, microwave-crisping sequence instructions that instruct sequential steps of heating the frozen pizza in a microwave oven followed by crisping the crust upon a stovetop heat source, disposable crisping means that allow crisping on a stovetop without having to clean a pan, a substantially flat transfer element that is one of a transfer substrate or a combination transfer substrate and disposable crisping means. The package provides for rapid and convenient preparation of a frozen pizza with a more crisp crust than with present frozen pizzas.

This application is a Continuation-in-Part Application of Ser. No. 14/183,602 filed Feb. 4, 2014, which is a Continuation-in-Part Application of Ser. No. 14/073,949, filed on Nov. 7, 2013, which claims the benefit of U.S. Provisional Patent Application No. 61/768,603, filed Feb. 25, 2013.

### BACKGROUND OF THE INVENTION

1. Field of the Invention

The present invention relates generally to frozen pizzas. Particularly, the present invention relates to a frozen pizza devices and methods.

2. Description of the Prior Art

Pizza is a widely consumed food item in the United States. Despite the subjective nature of food preference, there is general acceptance that pizza procured where it is freshly prepared, such as at a pizzeria, and immediately consumed after baking, is especially desirable. Considered less desirable are pizzas that are preserved by freezing, and later prepared to be eaten. This manner of pizza consumption may be necessitated when freshly baked pizza is not locally available or cannot be conveniently procured at the very time when pizza is desired. Contributing to making frozen pizza less desirable than fresh pizzas is the need for the consumer to prepare the frozen pizza to make it consumable.

Presently, the consumer is required to prepare frozen pizzas by either baking them or heating them in a microwave oven, and there are major shortcomings to both processes. Considerable time is required for the consumer to bake a frozen pizza, and achieving even heating and a crisp pizza crust with microwave preparation remains problematic.

Numerous frozen pizzas are widely sold at supermarkets and other food outlets and examples include: “Tony's Cheese Crispy Crust Pizza” produced by the Schwan Food Company, Bloomington, Minn.; “DiGiorno For One Traditional Crust Frozen Pepperoni Pizza” distributed by Nestle USA, Northbrook Ill.; “Bellatora Ultra Thin Crust Pizza” prepared by Bernatello's Pizza , Inc., of Maple Lake, Minn.; “Trader Giotto's Pizza 4 Formaggi Handmade Four Cheese Pizza” distributed and sold exclusively by Trader Joe's, Moravia, Calif.; “Red Baron Classic Crust” Pepperoni Pizza distributed by Schwan's Consumer Brands, Inc, Bloomington, Minn.; “Totino's Party Pizza” distributed by General Mills Sales. Inc, Minneapolis, Minn.; “Jeno's by Totino's Pizza for One” distributed by General Mills Sales. Inc, Minneapolis, Minn.; “Sabatasso”s Pizzeria Pizza Singles, Thin Crust” distributed by Schwan's Consumer Brands, Inc. Bloomington, Minn.; and “Kirkland Signature Pepperoni Pizza, Rising Crust” distributed by Costco Wholesale Corporation, Seattle, Wash.

Such frozen pizzas are provided with instructions for consumer preparation by baking, and/or microwave heating. Baking instructions typically instruct the consumer to heat a conventional oven to between 350-450 degrees Fahrenheit, and this may take from about 20-25 minutes depending upon the particular oven and the advised temperature. Once the oven is heated, the consumer is instructed to bake the pizza at the full recommended heat for a time period ranging from 7 to 25 minutes. The process of baking a frozen pizza therefore takes from about 25 to 45 minutes.

To exemplify this, the aforementioned Tony's pizza instructs heating the oven to 400° F. and cooking on a rack for 12-14 minutes. The aforementioned DiGiorno pizza instructs heating the oven to 450° F. and placing the pizza directly on the center rack of the oven to bake for 17-19 minutes or until the cheese is melted. Instructions for the aforementioned Red Baron Pizza are to heat the oven to 400° F. and cook the pizza for 17-19 minutes. Similarly, Kirkland Pizza instructions are to heat oven to 425° F. and bake for 22-25 minutes or until cheese is melted and edges are golden brown, where total preparation time is likely to exceed 40 minutes.

Presently available frozen pizzas that are instructed for microwave heating can be prepared for serving considerably more quickly than those instructed for baking. To illustrate this, the cooking instructions that are provided with above noted Tony's pizza instructs the consumer to microwave the pizza on high for 3.5 to 4 minutes until the center is melted. Above noted DiGiorno pizza instructs the consumer to microwave the product from 3.5-5.5 minutes according to the strength of the microwave oven: 5 minutes and 30 seconds at 600-800 watts, 4 minutes and 30 seconds at greater than 800 and up to 1100 watts, or 3 minutes and 30 seconds at greater than 1100 watts. The consumer is instructed to continue cooking the pizza in 30 second intervals if the cheese is not melted.

While allowing a shorter preparation time compared to baking, the crust resulting from microwave heating tends to be less crisp when compared to baked pizzas, either freshly baked pizzas or frozen pizzas that have been prepared for consumption by baking. Rather than a chewy crust with a crisp outer layer that can result from baking, microwave preparation of frozen pizzas results in crusts that tend to be more soggy, spongy, doughy, and unevenly cooked than the crusts of baked pizzas. Unsatisfactory crusts of microwave pizzas are the subject of numerous innovations that attempt to improve upon them.

U.S. Pat. No. 4,283,424 issued to Bone et al. discloses that: “ . . . most if not all pizza attempted to be cooked in a microwave oven have been characterized by . . . an extremely unpalatable, often soggy crust.” Bone et al. teaches a composite crust with a first layer of cracker-type dough material with 5% or less moisture and a second baked bread dough crust having a moisture content of 20-40% where the drier layer is capable of absorbing water vapor generated in microwave cooking.

U.S. Pat. No. 6,627,242 issued to McPherson, et al. similarly points out that microwaved cereal products such as pizza crusts are generally not pleasing to the palate, that it is difficult to generate a crisp or brown outer crust, and that microwave heating is generally uneven. McPherson et al. state that susceptors may be employed for these reasons, but that the use of susceptors does not preclude uneven heating and/or uneven crisping of ordinary pizza crust, and teach an alternative to ordinary dough, namely a pizza crust comprising mesophase-gel, which when baked in a microwave oven rises in a manner similar to conventional baked-oven pizza crust. The resulting crust is described as having a firm texture and being “palatable.”

U.S. Pat. No. 5,519,195 issued to Keefer, et al. also relates to susceptors, explaining that they are devices that become heated by incorporating materials that absorb microwave energy to improve upon microwave cooking. This disclosure points to serious disadvantages with susceptor use: risk of overheating, of breakdown of the susceptor material and even generation of toxic products, and teaches preventive modifications.

U.S. Pat. No. 6,204,492 issued to Zeng et al. concordantly discloses that food cooked in a microwave oven generally does not exhibit the texture, browning, and/or crispness that are acquired when food is cooked in a conventional oven. Zeng et al. also discuss employment of susceptor material to focus heat on the food, however disclose hot and cold spots, potential for fire, and arcing with these devices. Zeng, et al. seek to overcome such problems with the placement and pattern of metallic segments.

Despite such attempts to improve upon microwave preparation of frozen pizza, the present state of the art may best be reflected in instructions provided with presently marketed microwave pizzas that recommend baking rather than microwave heating for “best results” or to achieve a crisp crust. “Tony's Pizza for One” instructs both methods, but recommends baking for best results: “Microwave on high 2 minutes 30 seconds to 3 minutes 15 seconds . . . ” and “Oven instructions: (recommended for best results) pre-heat oven to 425° F. . . . ” Similarly, “Microwavable Tony's Crispy Crust Pepperoni Pizza” includes microwave instructions, but adds: “Oven Instructions for a Crisp Crust.” Kroger brand “Classic Crispy Crust 3 Minute Microwave Pizza” has microwave instructions, but also conventional oven directions that state: “for a crisp crust, bake pizza directly on oven rack.” “Sabatasso's Pizzeria Singles Thin Crust” comes with microwave instructions and also conventional oven instructions that are: “Recommended for a crisper crust.”

The strength and distribution of microwave energy is known to vary from microwave oven to oven, and it is acknowledged that microwave cooking is spatially uneven and that heat application may vary in accordance with placement of a foodstuff in the microwave. Food-borne illness has been associated with pathogen persistence consequent to non-uniform heating of frozen pizza.

What is therefore needed is a frozen pizza that can be more quickly prepared by the consumer than present frozen pizzas instructed for baking, and that has a crust that is more akin to baked pizza, and preferably to pizzeria-type baked pizza that is baked on a heated brick, than to the crust of present frozen microwave pizzas after they are prepared by microwave according to their instructions.

### SUMMARY

The present invention is for frozen pizza preparation devices and methods that enhance the convenience of preparing a frozen pizza quickly and so as to have a crisp crust, [by further incorporating] that incorporate a disposable crisping means to reduce or eliminate the need to clean an ordinary stove top pan following its use for crisping a pizza crust.

The present choices of baking or microwaving frozen pizzas to prepare them for consumption are not entirely satisfactory: baking a frozen pizza is time consuming, and microwave preparation results in crusts that lack the texture and crispness of baked pizzas. Resulting crusts from microwave heating are not as crisp or evenly cooked as when a pizza is baked. Adaptations and methods to overcome the shortcomings of microwave pizza preparation are described above and themselves have shortcomings, for example, the provision of a portion of crust with a cracker layer to imitate the crispness of ordinary baked pizza cannot be expected to result in a crust having the same texture and crispness of conventional baked pizza, but rather to result in a cracker-like imitation; there is risk of overheating and generation of toxic materials with the employment of susceptors; and use of chemical additives to emulate natural foods is undesirable.

The prior applications of Weinstein, Ser. Nos. 14/183,602 and 14/073,949, which are herein incorporated by reference, teach means and methods for a consumer to prepare a frozen pizza where the speed of preparation is far more rapid than required for conventional baking of frozen pizza, and where the resulting crust is substantially more crisp and evenly heated than with present rapid methods for preparing frozen pizza by microwave heating. The applications of Weinstein teach that a microwave step is essential to thaw and heat frozen pizza samples as rapidly as was desired by the inventors. Microwave heating of frozen pizza crust layered with frozen toppings weighing approximately 80 grams (in total) in a 1000 watt output microwave oven for less than one minute (i.e. about 40 seconds) was found to sufficiently thaw, heat, and melt crust and toppings that included tomato sauce, pepperoni, and cheese. It was anticipated that larger pizza components such as more voluminous toppings or a thick crust, yet sized to fit into a microwave oven, and/or the use of a less powerful microwave oven, would require proportionally more time, but not exceeding about 7 minutes, which is a fraction of the time to bake a frozen pizza. Attempts at stovetop heating as an alternative required considerably more time than microwave heating and resulted in burning the bottom of the pizza crust before sufficiently thawing and heating toppings.

The Weinstein applications further disclose that the pizza crust resulting from microwave heating was substantially less crisp than the crust of comparable pizza prepared by baking. Lifting the edge of tested microwave heated pizzas caused the pizza to sag due to their being soggy and insufficiently crisp. Microwave heated frozen pizzas were also found to be less evenly reheated than desired, some areas being hotter than others, even if on a rotating tray in the microwave oven and also turned to two different positions in the oven, which would a likely limit consumer acceptability for using a microwave oven.

According to the Weinstein applications, an additional step of [heating] crisping microwaved heated frozen pizza on an open stovetop pan resulted in more even heating of the pizza crust and toppings and, especially, in sought-after crust crispiness. This outcome was achieved with a surprisingly short period of open skillet heating: about 30-90 seconds for a thin crust pizza weighing from about 75-300 grams. It was anticipated that crisping larger pizza crusts and toppings, for example, a pizza with a thick crust, or crisping at lower heat, would be expected to require more time, but not more than about 3-4 minutes depending upon the cooking vessel, intensity of heat, and distance from heat source.

It was expected that subjecting a microwave reheated frozen pizza to high stovetop heat on a skillet would cause the crust to burn as quickly as might occur when ordinarily baking fresh pizza, and that there would be little leeway between crisping the crust and burning it. In contrast to expectation, stovetop heating at high heat could be surprisingly continued for a period past when the crust was sufficiently crisped without the crust burning. It was hypothesized that the vaporization of water in the crust during the preceding microwave step, while producing undesirable sogginess, also served a protective function that prevented the crust from burning during the subsequent step of pan crisping. Regardless of the reason, the unexpected latitude for crisping a microwave-reheated frozen pizza crust on a stovetop pan or skillet without burning it, even though the crust had been previously baked, suggested a reliable preparation method for lay individuals and commercial viability.

Embodiments of the present invention are derived from the aforementioned disclosures of Weinstein, and further afford a consumer greater convenience by the provision of disposable crisping means that reduces or eliminates the need to clean a stovetop pan after it is used for crisping the pizza.

Frozen pizza rapid preparation packages of the present invention now contain the functionally interdependent elements of: 1) a frozen pizza with a crust that has been sufficiently baked prior to freezing as to not require substantial time to further bake the crust; 2) microwave-crisping sequence instructions that instruct sequential steps of heating the frozen pizza in a microwave oven followed by stovetop crisping of the crust; 3) a disposable crisping means thereby reducing or eliminating the need to clean an ordinary stove top skillet; and 5) packaging that serves to unify these elements.

In another embodiment, the present invention further includes a transfer substrate that is a device to facilitate the transfer of heated pizza from a microwave oven to a stovetop heat source for crisping. Methods to employ these elements are further elaborated below.

The term “pizza” is herein intended to mean a crust and toppings according to common usage and according to the referenced Weinstein disclosures. Pizza crusts of the present invention may be baked with toppings upon them, or without toppings upon them prior to the pizza being frozen. It is essential that pizza toppings of the present invention be prepared prior to freezing in a manner commensurate with prudent culinary practice, such that microwave reheating suffices to prepare them for consumption.

The element of disposable crisping means of the present invention is envisioned to reduce or eliminate the need to clean a conventional stovetop pan used to crisp a pizza crust. As will be further elaborated, the present invention envisions disposable crisping means that include: a disposable liner for an ordinary stove top pan such that the pizza does not directly contact the pan when it is crisped; a disposable pan liner of microwave compatible material that can be utilized to underlie a pizza when it is microwave heated, transfer the pizza to a stovetop pan, and underlie the pizza crust when it is crisped upon a stovetop pan, and and provision of a disposable stove top pan upon which to crisp the pizza crust.

The present invention achieves these and other objectives by providing a frozen pizza rapid preparation package. The rapid preparation package includes a frozen pizza, a disposable crisping means, microwave-crisping sequence instructions, and a unifying packaging. The microwave-crisping sequence instructions instruct sequential steps of heating the frozen pizza in a microwave oven followed by crisping the pizza crust over a stovetop heat source.

In another embodiment, the frozen pizza rapid preparation package further includes a substantially flat transfer element. The substantially flat transfer element is further (1) a transfer substrate to transfer heated pizza from a microwave oven to a heated stovetop pan, or (2) a combination transfer substrate and disposable crisping means. The unifying packaging conveniently unifies the frozen pizza, the disposable crisping means, the sequence instructions, and the substantially flat transfer element. In embodiments where the transfer substrate is also intended to function as a disposable crisping means, it is then an alternative for a separate disposable crisping means.

In one embodiment of the present invention, the frozen pizza is selected from the group consisting of a pizza crust and toppings thereupon that have been baked together prior to being frozen, and a pizza crust that has been baked and toppings then layered thereupon prior to their being frozen.

In another embodiment of the present invention, the frozen pizza has a characteristic selected from the group consisting of a weight in the range of about 50 to 1000 grams, and a largest dimension that measures in the range of about 6 to about 14 inches.

In a further embodiment of the present invention, the instructed time for microwave heating is selected from the group consisting of a range of about 40 seconds to about 7 minutes and a range of about 1.5 to 4 minutes.

In still another embodiment of the present invention, the instructed time for stovetop crisping is selected from the group consisting of a range of about 30 seconds to about 4 minutes and a range of about 30 seconds to about 2 minutes.

In yet another embodiment of the present invention, the microwave-crisping instructions includes instructing the use of the transfer element to transfer microwave heated pizza from a microwave oven to the disposable crisping means.

In another embodiment of the present invention, the combination transfer element is devised of material is microwave compatible and stovetop compatible.

In another embodiment of the present invention, a method of making a frozen pizza package and a method of heating a frozen pizza are disclosed. In the broadest method, the method of heating a frozen pizza includes obtaining a frozen pizza with a crust that is sufficiently baked as to not require substantial further baking, heating the frozen pizza in a microwave oven for a predefined time period resulting in a heated pizza, and, after the prior heating step, immediately crisping the pizza crust of the heated pizza over a stovetop heat source for a predefined time period.

### BRIEF DESCRIPTION OF THE DRAWINGS

FIG. 1 schematically illustrates one embodiment of the frozen pizza preparation device of the present invention showing a frozen pizza upon a transfer element, and both upon a disposable crisping means that functions to line an ordinary stove top skillet.

FIG. 2 is a front view to illustrate a microwave oven heating a frozen pizza upon a transfer element, where both are upon a rotating table inside the microwave oven.

FIG. 3 depicts, in perspective view, the transfer of hot, microwave heated pizza to an ordinary stovetop pan that is lined with a disposable crisping means such that the pizza does not directly contact the pan when it is crisped.

FIG. 4 illustrates another embodiment of the frozen pizza preparation device of the present invention and schematically shows a frozen pizza upon a transfer element that is also intended to act as a disposable crisping means. Front and a back unifying covers are illustrated, where the front cover has microwave-crisping sequence instructions upon its surface for preparing the pizza.

FIG. 5 is a front view that is intended to illustrate a microwave oven heating a frozen pizza upon the transfer element, both upon a rotating table inside the microwave oven.

FIG. 6 depicts, in perspective view, transfer of hot microwave heated pizza to a stovetop pan. The pizza is held upon the transfer element, and in this instance, both pizza and transfer element are dropped into the pan, such that the pizza does not directly contact the pan when it is crisped. In this embodiment, the transfer element therefore also acts as both a transfer substrate and a disposable crisping means that can be disposed of after the pizza crust is crisped.

FIG. 7 depicts the pizza of FIG. 6 in a stovetop skillet, where the transfer element is interposed between the pizza crust and pan, thereby acting as a disposable crisping means as well as a utensil to transfer the pizza.

FIG. 8 is a diagrammatic perspective view of an alternative embodiment where a frozen pizza is depicted above a transfer substrate and where both are further above a disposable crisping means that is an inexpensive disposable pan that can be disposed of after the pizza crust is crisped. The pizza and transfer substrate are unified within the disposable pan by a cover, and microwave-crisping sequence instructions for preparation of the pizza are upon a surface of said cover.

### DETAILED DESCRIPTION OF THE EMBODIMENT(S)

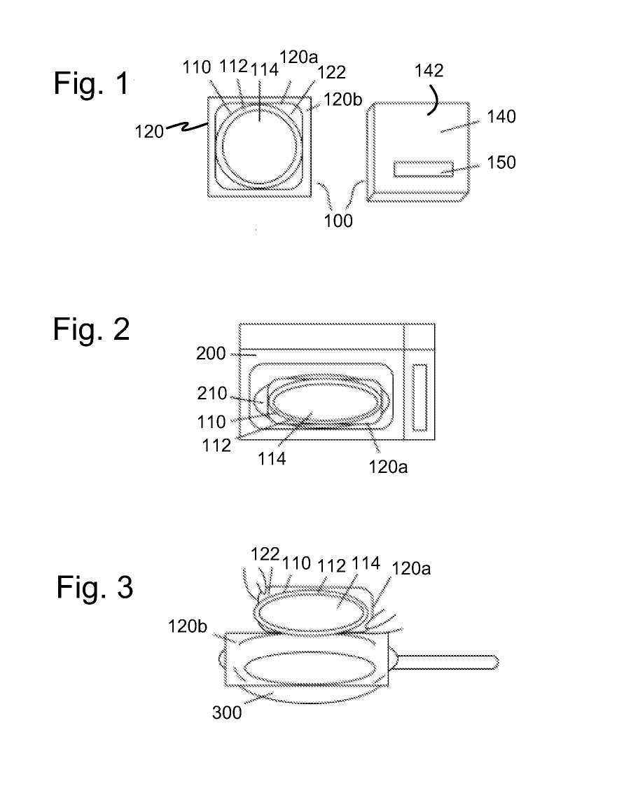

The embodiments of the present invention are illustrated in FIGS. 1-8. FIG. 1 schematically illustrates one embodiment of the frozen pizza preparation package 100 of the present invention showing a frozen pizza 110 having a crust 112 and toppings 114, a transfer element 120 that is a transfer substrate 120a having a grasping adaptation 122 upon which the frozen pizza 110 is disposed, and a disposable crisping means 120b upon which the transfer substrate 120a is disposed where the crisping means 120b functions to line an ordinary stove top skillet. A unifying container 140 is illustrated to have microwave-crisping sequence instructions 150 for preparing the pizza upon a surface 142.

It is contemplated that the frozen pizza 110 has a crust 112 that has been sufficiently baked prior to being frozen as to not require substantial time for baking to prepare it for consumption. The pizza crust 112 may either have been baked with toppings 114 layered upon it, or baked without toppings 114 that are later layered upon it prior to freezing. Further, it is contemplated that the frozen pizza 110 is proportioned commensurate with preparing it in an ordinary microwave oven and ordinary stovetop pan, therefore a weight in the range of about 50 to 1000 grams, and planar dimension in the range of about 6 to about 14 inches. While a round pizza 110 is illustrated, alternative shapes are also contemplated. A peripheral area of pizza crust 112 without topping 114 is typical such that the toppings are more likely to remain upon the crust during microwave-crisping preparation.

The transfer element 120 is illustrated to have sufficient dimension to underlie the pizza crust, and also to have a grasping adaptation 122 that is adequately distant from the pizza 110 that it can be grasped without touching the pizza when it is hot. Variations in sizes and shapes are contemplated, both commensurate with the size and shape of the pizza, and according to desired configurations for grasping and transferring the pizza. While planar in illustration, folded or otherwise dimensional embodiments are contemplated, however providing a planar, substantially flat surface to conform to the bottom of a pizza crust. It should also be noted that the transfer element 120 may be (1) a transfer substrate 120a to transfer heated pizza from a microwave oven to a heated stovetop pan that is covered with a disposable crisping means that is a pan liner, or to a disposable stovetop pan, or (2) a combination transfer substrate 120a and disposable crisping means 120b.

FIG. 2 is a front view illustration of a microwave oven 200 heating a frozen pizza 110, that has been removed from its packaging 140, having a crust 112 and toppings 114, upon a transfer substrate 120a, where both pizza 110 and transfer substrate 120a are upon a rotating table 210 inside the microwave oven 200.

It is contemplated that the time required for microwave heating will vary with the strength and configuration of the microwave oven and the size of the pizza, in a range from about 40 seconds for small pizzas to about 7 minutes for very large ones. For pizzas that might be consumed by one to a few people (weigh from about 300 to 1200 grams, and measuring about 8-14 inches in largest dimension), a range of about 1.5 to 4 minutes of microwave heating on high for an ordinary microwave oven is contemplated. While moving pizzas once during microwave heating is often advised, this is likely to prove unnecessary as the crisping step serves to even out the application of heat over the area of the pizza.

FIG. 3 is a perspective view illustration to depict the transfer of a microwave heated pizza 110, having a crust 112 and toppings 114, to an ordinary stovetop pan 300, where the hot pizza is situated upon the transfer substrate 120a to transfer it without touching the hot pizza. The pizza is lifted from the microwave oven by holding the transfer substrate 120a and without touching the hot pizza. The transfer substrate 120a is shown being held by a grasping adaptation 122 that is sufficiently distant from the hot pizza 110 as to avoid touching the pizza.

The stovetop pan 300 is lined with a disposable crisping means 120b such that the pizza 110 will not directly contact the pan 300 when the crust 112 is crisped over heat (crisping over heat not illustrated). While illustrated as square in shape, shapes and sizes of such pan liners are contemplated to vary according to the size and shape of the pizza and crisping pan. The disposable crisping means 120b can be thrown away after the pizza crust 110 is crisped, leaving a relatively clean pan 300 versus if the pizza crust 112 was crisped directly on the pan 300. The disposable crisping means 120b is intended be inexpensive enough for an ordinary consumer to allow a single use. Ordinary aluminum foil is one choice of material, and Reynolds Wrap, or Reynolds Wrap non-stick, both products of Reynolds Kitchens, Richmond, Va., are examples of a material that are useable.

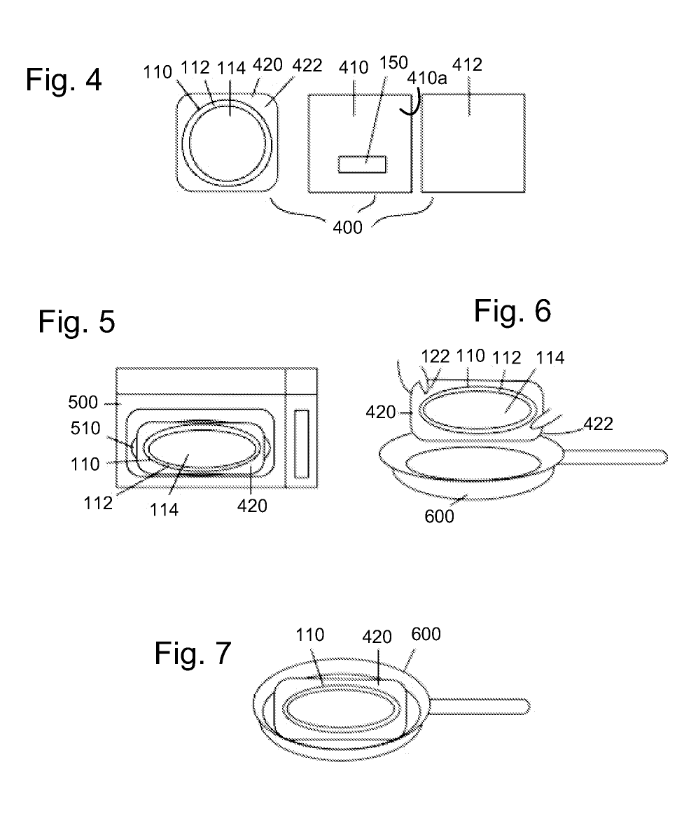

FIGS. 4, 5, and 6 depict another embodiment of the present invention. FIG. 4 illustrates a frozen pizza package 400, schematically showing a frozen pizza 110, having a crust 112 and toppings 114, layered above a transfer element 420 that has a grasping adaptation 422 that is located at a corner distant from the edge of the pizza 110. In this embodiment, the transfer element 420 is intended to function both as a transfer substrate 120a and as a disposable crisping means 120b. Front and back packaging covers 410, 412 are illustrated, where the front cover 410 has a surface 410a that displays microwave-crisping sequence instructions 150 for preparing the pizza 110. The frozen pizza preparation package 400 is unified by sandwiching the pizza 110, and transfer element 420 between the front cover 410 that displays microwave-crisping sequence instructions 150 and the back cover 412. The entirety of frozen pizza package 400 may be joined together by wrapping or packaging means that are known in the art, for example, shrink wrapping or taping.

While the covers 410 and 412 are illustrated as square panels, other shapes as might be dictated by the shape of the pizza or appearance are contemplated. Alternative packagings are contemplated to unify the frozen pizza package 400, such as utilizing a box or a wrapper rather than the depicted front and back covers 410, 412. In this instance, microwave-crisping instructions 450 might alternatively be printed upon a sheet of paper within the package or be upon a surface of the box or alternative wrapper.

FIG. 5 is a front view illustration of a microwave oven 500 heating a frozen pizza 110 upon a transfer element 420, both upon a rotating table 510 inside the microwave oven 500. Functionally, the pizza 110, and transfer element 120 has been removed from its packaging, and, the pizza 110 is microwave heated atop the transfer element 420.

FIG. 6 is a perspective view depicting a method of transfer of a microwave heated pizza 110 to an ordinary stovetop pan 600. The illustrated transfer element 420 is relatively square, where the pizza 110 is round, thereby allowing the consumer to grasp the transfer element 420 at its corners, which act as a grasping adaptation 422 away from the hot pizza. It is essential for the transfer element 420 to have such an area that can be grasped and that is not in direct contact with the hot pizza. Alternative configurations to underlie the pizza crust bottom and also allow grasping away from the crust are contemplated.

In this instance where the transfer element 420 also serves as both a transfer substrate 120a and a disposable crisping means 120b, both pizza 110 and transfer element 420 are placed into, or simply dropped into the pan 600, which has preferably been heated while the pizza had been in the microwave oven. The transfer element 420 can then be disposed of after the pizza crust is crisped.

FIG. 7 illustrates, in perspective view, that the transfer element 420 is then positioned between the bottom of the pizza 110 and the stovetop pan 600. In this instance, the transfer element 420 acts as both a transfer substrate 120a and a disposable crisping means 120b, where it might alternatively be termed a “transfer substrate-disposable crisping means.” Following crisping, the pizza 110 can be lifted by the “transfer element-disposable crisping means” 420 if an aspect is situated away from the pan, or slid from the stovetop pan 600 onto an ordinary plate for consumption. Alternatively, it is contemplated that the package elements of FIG. 4, namely backing 412 or cover 410 might be used instead of a plate if desired. The “transfer element-disposable crisping means” 420 can then be disposed of, leaving a relatively clean stovetop pan.

It is essential that the transfer element 420 of this embodiment where a transfer substrate 120a also acts as a disposable crisping means 120b be devised of material that is microwave and stovetop cooking compatible. It is desirable that it be inexpensive enough to qualify as disposable for ordinary consumers. It is further desirable that the material does not tend to stick to the pizza 110. It is contemplated that thermoplastic, silicon, ceramic or other suitable materials might be utilized or devised, however, it was found that heat resistant paper, in particular, culinary parchment paper, has the desired properties of: microwave compatibility, sufficient structural integrity to lift hot pizza from the microwave oven after microwave heating, non-stick quality, and heat resistance sufficient to withstand stovetop temperatures for the few minutes required to crisp the pizza crust. Parchment paper having these qualities is parchment paper distributed by Publix Super Markets, Inc. of Lakeland, Fla., and Reynolds® parchment paper, a product of Reynolds Kitchens, Richmond, Va., and both are considered to represent this genre. We have found these materials to stay intact when under a pizza crust that is being crisped at full stovetop heat for a few minutes. In the event of prolonged crisping, some paper charring has been noted that we have found relatively effortless to wipe off the pan.

A significant advantage of such an embodiment essentially comprising the simple elements of a pizza, culinary parchment paper, novel preparation instructions, and unifying wrapping is its potential to inexpensively provide a far more desirable frozen pizza product than heretofore available to a consumer.

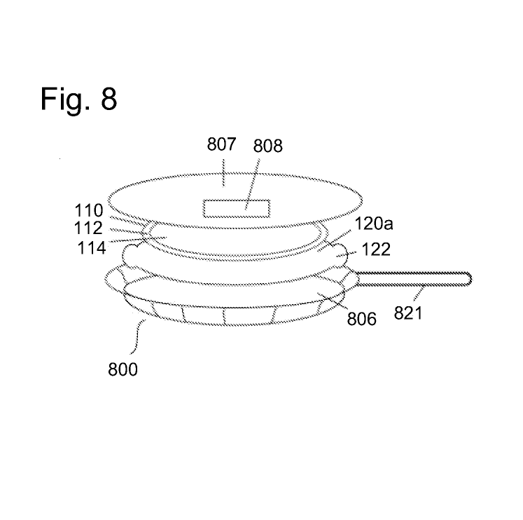

FIG. 8 is a diagrammatic perspective view of an alternative embodiment 800 of the present invention where a frozen pizza 110, having a crust 112 and toppings 114, is depicted layered above a transfer substrate 120a that has a grasping adaptation 122. Both pizza 110 and transfer substrate 120a are further layered upon a disposable crisping means, that in this instance is an inexpensive pan 806 with a handle 821, that functions as a disposable substitute for an ordinary stove top skillet and can be disposed of after the pizza crust 112 has been crisped. A cover 807 displaying microwave-crisping instructions 808 to cover the disposable crisping means 120b that is a pan 806 is envisioned to enclose and unify these elements.

In practice, the consumer follows the microwave-crisping instructions 808 by removing the cover 807 and placing the pizza 110 upon the transfer substrate 120a in a microwave oven to be microwave thawed and heated (not illustrated). The instructions further instruct removing the pizza 110 and the transfer substrate 120a from the microwave oven by grasping the transfer substrate 120a by its grasping means 122 and placing the pizza 110 into the disposable crisping means 120b that is a disposable stovetop pan 806 with a handle 821, and crisping the pizza crust 112 over stovetop heat in the disposable pan 806 (crisping over heat not illustrated).

The disposable crisping means 120b is sufficiently inexpensive for an ordinary user to dispose of it after a single use. One example of a single-use stovetop heating pan 806 is the folded-sheet aluminum pan of the “Jiffy pop” popcorn package, a product of ConAgra Foods. The crusts of microwave thawed and heated frozen pizza samples have been satisfactorily crisped utilizing this pan. Modifications are contemplated as in size and shape of the disposable heating vessel to include size and shape to fit pizzas, reconfiguration(s) of the bottom of the device to elevate the pizza crust above direct heat, and variations in means for grasping the pan. Also, a range of instruction as to technique for crisping the pizza crust are contemplated, for example, heating directly on the stovetop, raising the pan above the stovetop, heating the pizza crust with the pan stationary, or moving it during crisping, shaking the pan to move the pizza within such that the pizza does not stick to the pan, and range of cooking heat and cooking time, as within the scope of the invention.

The present invention teaches devices and methods to provide a consumer with a frozen pizza package, where the pizza can be more quickly prepared than by baking, and where a more crisp and evenly heated crust is achieved in comparison to microwave-prepared frozen pizzas.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A frozen pizza rapid preparation package comprising:
a frozen pizza;
microwave-crisping sequence instructions that instruct sequential steps of heating the frozen pizza in a microwave oven followed by crisping the pizza crust over a stovetop heat source;
a disposable crisping means selected from the group consisting of (1) a disposable pan liner, (2) a transfer substrate to further line a stovetop pan, and (3) a disposable stovetop pan; and
a unifying packaging for the frozen pizza, the sequence instructions, and the disposable crisping means.

2. The frozen pizza package of claim 1 further comprising a substantially flat transfer element that is a transfer substrate.

3. The frozen pizza package of claim 1 wherein the frozen pizza is selected from the group consisting of a pizza crust and toppings thereupon that have been baked together prior to being frozen, and a pizza crust that has been baked and toppings then layered thereupon prior to their being frozen.

4. The frozen pizza package of claim 1 wherein the frozen pizza has a characteristic selected from the group consisting of a weight in the range of about 50 to 1000 grams, and a largest dimension that measures in the range of about 6 to about 14 inches.

5. The frozen pizza package of claim 1 wherein the instructed time for microwave heating is selected from the group consisting of a range of about 40 seconds to about 7 minutes and a range of about 1.5 to 4 minutes.

6. The frozen pizza package of claim 1 wherein the instructed time for stovetop crisping is selected from the group consisting of a range of about 30 seconds to about 4 minutes and a range of about 30 seconds to about 2 minutes.

7. The frozen pizza package of claim 1 wherein the microwave-crisping sequence instructions includes instructing the use of the disposable crisping means that is a transfer substrate to transfer microwave heated pizza from a microwave oven to a stovetop pan.

8. The frozen pizza package of claim 1 wherein the disposable crisping means that is a transfer substrate is devised of material that is microwave compatible and stovetop compatible.

9. The frozen pizza package of claim 8 wherein the disposable crisping means that is a transfer substrate material is paper, silicone, or thermoplastic polymer.

10. The frozen pizza package of claim 9 wherein the disposable crisping means that is a transfer substrate material is parchment paper.

11. The frozen pizza package of claim 2 wherein the transfer element is microwave compatible and devised of paper, silicone, or thermoplastic polymer.

12. The frozen pizza package of claim 1 wherein the disposable crisping means that is a disposable pan liner or a disposable stovetop pan is comprised of aluminum foil.

13. The frozen pizza package of claim 1 wherein the unifying packaging has a surface that displays the microwave-crisping sequence instructions upon it.

14. The frozen pizza package of claim 2 wherein the microwave-crisping sequence instructions instruct situating a disposable crisping means that is a disposable pan liner upon a stovetop pan, and instruct utilizing the transfer element that is a transfer substrate to transfer heated pizza from a microwave oven to the disposable crisping means situated atop the stovetop pan.

15. The frozen pizza package of claim 8 wherein the microwave-crisping sequence instructions instruct utilizing the disposable crisping means that is a transfer substrate to transfer heated pizza from a microwave oven onto a stovetop pan, where the transfer substrate is interposed between the pizza and the stovetop pan during crisping.

16. The frozen pizza package of claim 2 wherein the microwave-crisping sequence instructions instruct utilizing the transfer element that is a transfer substrate to transfer heated pizza from a microwave oven to a disposable crisping means that is a disposable stovetop pan.

17. A method of making a frozen pizza preparation package usable by a consumer, the method comprising;
preparing a pizza with a crust that is sufficiently baked as to not require substantial further baking;
freezing said pizza;
devising microwave-crisping sequence instructions that instruct sequential steps of heating the frozen pizza in a microwave oven followed by crisping the pizza crust over a stovetop heat source;
devising a disposable crisping means selected from the group consisting of (1) a disposable pan liner, (2) a transfer substrate to further line a stovetop pan, and (3) a disposable stovetop pan;
devising a unifying package; and
incorporating the frozen pizza, the sequence instructions, and the disposable crisping means together with the unifying package.

18. The method of claim 17 further comprising the steps of:
devising a substantially flat transfer element that is a transfer substrate; and
incorporating it together with the unifying package.

19. The method of claim 17 wherein the pizza preparing step further includes selecting one of a pizza crust and toppings thereupon that have been baked together prior to being frozen, or a pizza crust that has been baked and toppings then layered thereupon prior to their being frozen.

20. The method of claim 17 wherein the pizza preparing step further includes preparing a pizza having a weight in the range of about 50 to 1000 grams, and a largest dimension that measures in the range of about 6 to about 14 inches.

21. The method of claim 17 wherein the instruction devising step further includes selecting one of a microwave heating for a time that is a range of about 40 seconds to about 7 minutes or a range of about 1.5 to 4 minutes.

22. The method of claim 17 wherein the instruction devising step further includes stovetop crisping for a time selected from the group consisting of a range of about 30 seconds to about 4 minutes and a range of about 30 seconds to about 2 minutes.

23. The method of claim 17 wherein the instruction devising step further includes instructing the use of the disposable crisping means that is a transfer substrate to transfer microwave heated pizza from a microwave oven to a stovetop pan.

24. The method of claim 17 wherein the devising a disposable crisping means that is a transfer substrate step further includes selecting a material that is both microwave and stovetop compatible.

25. The method of claim 17 wherein the devising a disposable crisping means that is a transfer substrate further includes selecting a material that is one of paper, silicone, or thermoplastic polymer.

26. The method of claim 25 wherein the devising a disposable crisping means that is a transfer substrate further includes selecting a material that is parchment paper.

27. The method of claim 18 wherein the devising a transfer element step further includes selecting a disposable crisping means that is a disposable stovetop pan.

28. The method of claim 18 wherein the devising a transfer element step further includes selecting a transfer element material that is microwave compatible and selecting a disposable crisping means that is comprised of aluminum foil.

29. The method of claim 17 wherein the devising a unifying package step includes providing a surface that displays the microwave-crisping sequence instructions.

30. The method of claim 18 wherein the devising microwave-crisping sequence instructions includes instruction for situating the disposable crisping means upon a stovetop pan, and utilizing the transfer element that is a transfer substrate to transfer heated pizza from a microwave oven to a disposable crisping means situated atop the stovetop pan.

31. The method of claim 17 wherein the devising microwave-crisping sequence instructions further includes instruction for utilizing the disposable crisping means that is a transfer substrate to transfer heated pizza from a microwave oven onto a stovetop pan, where the disposable crisping means that is a transfer substrate is interposed between the pizza and the stovetop pan during crisping.

32. The method of claim 18 wherein the devising microwave-crisping sequence instructions further includes instructing to utilize the transfer substrate to transfer heated pizza from a microwave oven to a disposable crisping means that is a disposable stovetop pan.

33. A method of heating a frozen pizza comprising:
obtaining a frozen pizza preparation package comprising:
a pizza with a crust that is sufficiently baked as to not require substantial further baking, where the pizza is then frozen;
microwave-crisping sequence instructions that instruct sequential steps of heating the frozen pizza in a microwave oven followed by crisping the pizza crust over a stovetop heat source;
a disposable crisping means selected from the group consisting of (1) a disposable pan liner, (2) a transfer substrate to further line a stovetop pan, and (3) a disposable stovetop pan; and
a unifying packaging incorporating the frozen pizza, the sequence instructions, and the disposable crisping means; and
following the microwave-crisping sequence instructions that instruct placing the frozen pizza crust into a microwave oven, heating the frozen pizza in the microwave oven, transferring the heated pizza from the microwave oven to the disposable crisping means, and crisping the pizza crust over a stovetop.

34. The method of claim 33 wherein the microwave-crisping sequence instructions instruct situating a disposable crisping means upon a stovetop pan, and transferring heated pizza from the microwave oven to the disposable crisping means situated atop the stovetop pan.

35. The method of claim 33 wherein the microwave-crisping sequence instructions instruct transferring heated pizza from a microwave oven onto a stovetop pan, wherein the disposable crisping means is used to transfer the pizza.

36. The method of claim 33 wherein the microwave-crisping sequence instructions instruct transfer of heated pizza from a microwave oven to a disposable crisping means that is a disposable stovetop pan.

37. A method of heating a frozen pizza comprising:
obtaining a frozen pizza with a crust that is sufficiently baked as to not require substantial further baking;
heating the frozen pizza in a microwave oven for a predefined time period resulting in a heated pizza;
after the prior heating step, immediately crisping the pizza crust of the heated pizza over a stovetop heat source for a predefined time period sufficient to crisp the crust.
